(19) United States
(12) Patent Application Publication
(10) Pub. No.: US 2005/0033721 A1
(43) Pub. Date: Feb. 10, 2005

(54) Location switch hard drive shim

(75) Inventors: Daryl Carvis Cromer, Apex, NC (US); Joshua James Jankowsky, Raleigh, NC (US); Andy Lloyd Trotter, Raleigh, NC (US); James Peter Ward, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/637,182

(22) Filed: Aug. 8, 2003

(51) Int. Cl. G06F 7/00

(52) U.S. Cl. 707/1

(57) ABSTRACT

A program product, method and an apparatus is disclosed to quickly and easily hide and expose and store and retrieve locally stored data. A location switch is employed in controlling the visibility and usability of files stored on a hard disk or other storage device included in the apparatus. A user selects from a plurality of location modes. Based on a selected location, files become visible and accessible or hidden and inaccessible. The files can be encrypted/decrypted on the disk and the encryption/decryption can be done in a transparent manner. The cryptology functions can also be tied to a cryptographic processor if one is available in the system.

### BACKGROUND OF THE INVENTION

This invention pertains to computer systems and other information handling systems and, more particularly, to a computer system in which various personalities allow alternative data files to be visible to applications.

Prior to the time when portable personal computers (PC's) became ubiquitous, the typical user first encountered computer use at the office. As the production of PC's increased, the prices decreased and eventually computers found their way into homes for personal use. Users would perform work-related tasks at an office computer, shut it down at the end of the day, and after a home commute, perform personal tasks at their home computer.

Portable PC's are fundamentally changing the way in which we work. Rather than having separate computers for office work and for home personal use, a single portable unit is increasingly being used. Typically, the portable unit is carried between the home and the office on a day to day basis. When a computer is used at various locations and for different purposes, there is no longer a clean separation between performing business work activities at the office and personal work performed at home. This results in a PC that contains critical business and personal information on the same hard disk drive.

Certain problems arise as a result of having business and personal data on the same hard disk drive. When backing up data, for example, where corporate policy forbids the use of corporate servers for personal use, a problem arises out of having to manually separate out personal data files such that the personal data files are not backed up on a corporate server.

Other problems which arise out of having business and personal data on the same PC include problems pertaining to privacy. In a normal working environment, a portable PC is normally connected to a corporate network. In some cases, for convenience and expediency, it is desirable for drives to be shared on the network. When drives are shared, however, private data intended for personal use will be exposed to co-workers on the network.

Likewise, when the portable PC is operating from a home location, sensitive and confidential work related data will be exposed to family members or other persons having physical access to the portable PC. Unless the user is taking steps to hide or encrypt each and every individual data file, the user's data is exposed to anyone having access to the portable PC. Even if encrypted, the existence of a file is apparent which itself could constitute a security breach unless the user manually hides the file by marking the file as read only.

### SUMMARY OF THE INVENTION

What is needed is a method to quickly and easily hide and expose and store and retrieve locally stored data. A location switch is disclosed which allows access to different files—as needed—based on a currently-selected location mode. If a user is in work mode, all work files are made available, all home related documents are hidden and inaccessible from all applications. In one embodiment, the files are encrypted on the hard disk. If for some reason the user needs to gain access to home related documents while at work, a quick change of the location switch grants access to the home related documents.

In one set of embodiments, the location of a computer system having a storage device which stores data is detected. Based on the detected location, a selected location or location mode is assumed. Files stored in the storage device are tagged in accordance with the selected location or location mode. A filter is implemented which passes files tagged according to the selected location and blocks files not tagged according to the selected location. As a part of the filtering process, files which are passed are stripped of the tag prior to presenting the file to a requesting application or other system resource.

In another set of embodiments, the location of a computer system having a storage device which stores data is detected. Based on the detected location, a selected location or location mode is assumed. Files stored in the storage device are tagged in accordance with the selected location or location mode. The contents of the tagged files are stored in an encrypted format on the storage device. A filter is implemented which passes files tagged according to the selected location and blocks files not tagged according to the selected location. As a part of the filtering process, files which are passed are stripped of the tag prior to presenting the file to a requesting application or other system resource. The contents of tagged files which are found to have been stored in an encrypted format are decrypted accordingly. Changes in assumed location are implemented in such a way as to not require the termination of existing applications.

Embodiments of the invention include embodiments as a program product, a method and an apparatus programmed or hardwired to execute the method or methods described herein.

### BRIEF DESCRIPTION OF THE DRAWINGS

Some of the purposes of the invention having been stated, others will appear as the description proceeds, when taken in connection with the accompanying drawings, in which:

FIG. 1 illustrates a program product configured in accordance with an embodiment of the present invention and stored on a first type of computer readable storage medium;

FIG. 2 illustrates a program product configured in accordance with an embodiment of the present invention and stored on a second type of computer readable storage medium;

FIG. 3 depicts the level at which the filter driver logically resides relative to other components of a computer system configured according to one embodiment of the present invention;

FIG. 4 illustrates the tagging performed by the filter driver configured in accordance with an embodiment of the present invention;

FIG. 5 is a flowchart illustrating the logic of the filter driver configured in accordance with an embodiment of the present invention;

FIG. 6 is a flowchart illustrating the logic of the filter driver configured in accordance with an embodiment of the present invention.

FIG. 7 is a block diagram of an apparatus configured in accordance with an embodiment of the present invention; and

FIG. 8 is a block diagram of an apparatus configured in accordance with an embodiment of the present invention.

### DETAILED DESCRIPTION OF THE ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

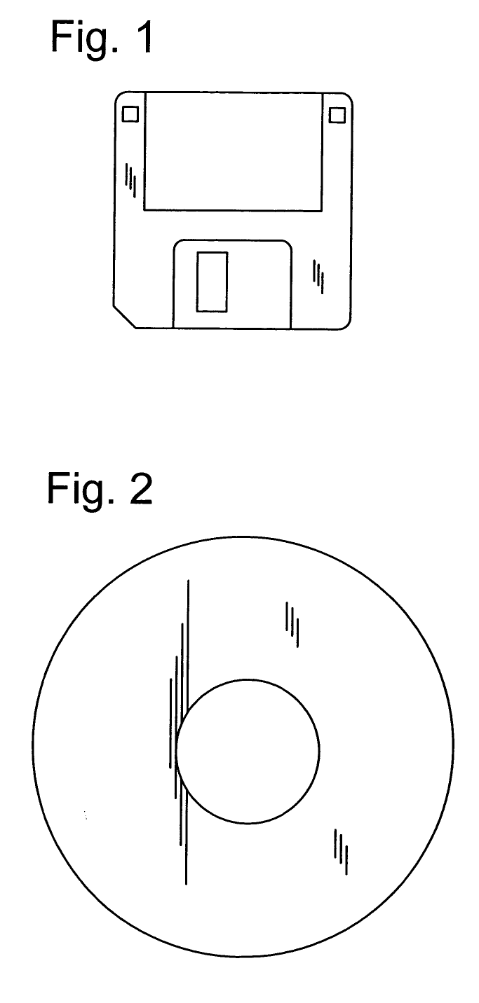

Referring now more particularly to the accompanying drawings, FIG. 1 illustrates a program product configured in accordance with an embodiment of the present invention and stored on a first type of computer readable storage medium. The storage medium of FIG. 1 is of the 3.5 inch floppy diskette type. The diskette medium is used to store program code which is to be executed on a computer system. Similarly, FIG. 2 illustrates a program product configured in accordance with an embodiment of the present invention and stored on a second type of computer readable storage medium. The storage medium of FIG. 2 is of the optical CD-ROM type. Although magnetic and optical media are used in the specific examples, any type of computer readable medium can be utilized. One skilled in the art would appreciate that the physical storage of program code physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements. The computer program product can also be stored at another computer and transmitted when desired to the user's workstation by a network or by an external network such as the Internet. Alternatively, the program product can be stored in a flash ROM residing on the computer system motherboard.

Computer systems of any type can be considered for use with the concepts as taught herein. As a consequence, many computer system details are not included, particularly where the details are independent of the teachings herein described. Although not intended to be limiting, the embodiments which follow are described relative to IBM® compatible personal computers running Microsoft® operating systems such as Microsoft® Windows® 2000 or Microsoft® Windows® XP®. However, any type of operating system can be used. Generally, the computers are of the laptop variety, however, non mobile systems can also benefit from the advantages to be described herein.

The code to be executed in one embodiment of the invention, once loaded from the storage medium, is executed as a filter driver. For Microsoft® operating systems, at the time of this writing, the filter driver can be implemented as an installable file system (IFS). For details on how to write an IFS, refer to the kit provided by Microsoft® entitled Microsoft® Windows® Server 2003 Installable File Systems Development Kit. This kit is a developer's kit for the kernel mode file system and file system filter driver models. The kit provides the interfaces for developers to write file systems and file system filters for Windows® 2000, Windows® XP, Windows® XPSP1 and Windows® Server 2003. Other operating systems have similar kits.

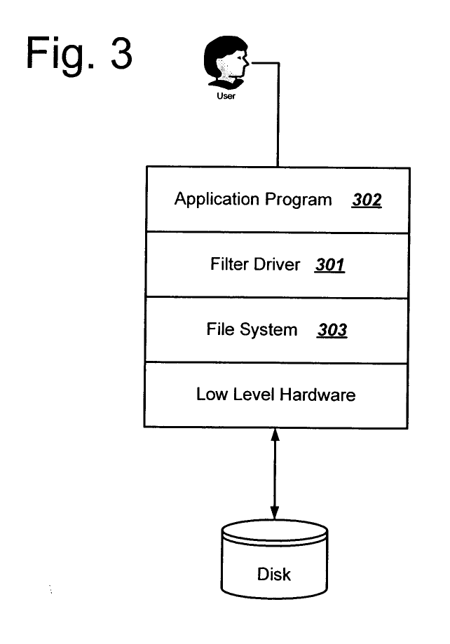

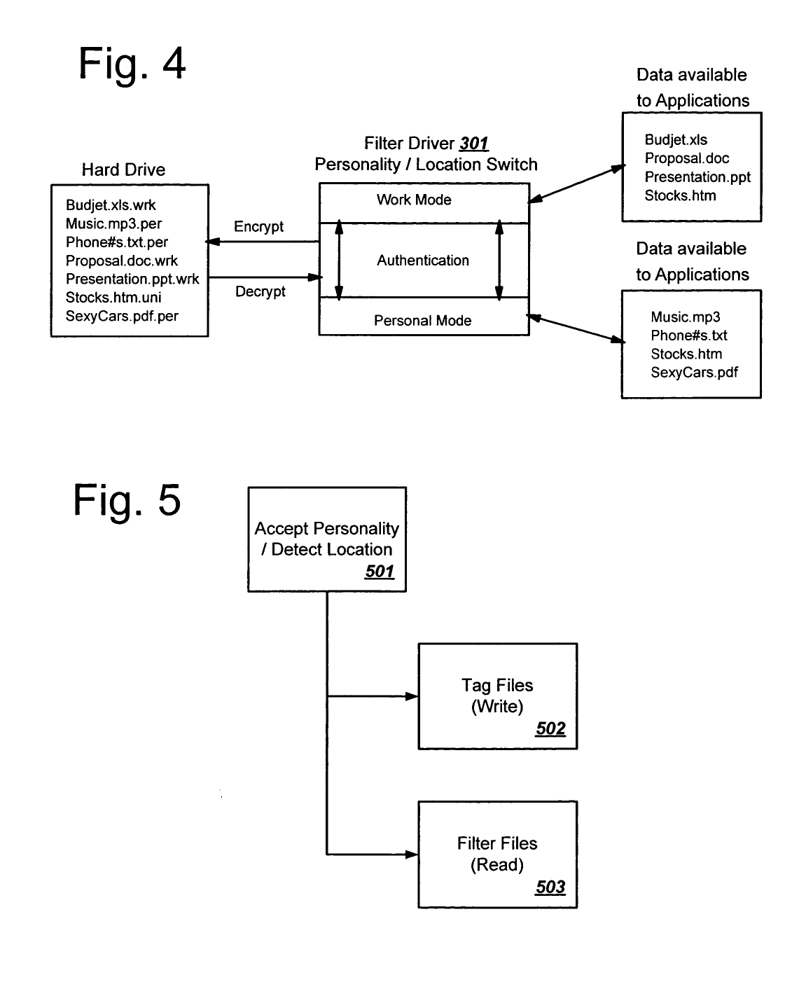

FIG. 3 depicts the level at which the filter driver 301 logically resides relative to other components of a computer system configured according to one embodiment of the invention the present invention. Filter driver 301 implements a personality or location switch and utilizes data tagging to filter locally stored info. The hard disk filter driver 301 installs and resides as an interface in-between the applications 302 (e.g. Explorer) and the file system and disk driver 303 (e.g. I/O Manager). Filter driver 301 filters the information to and from the hard drive via data tagging. An example of such data tagging is shown in FIG. 4. Still referring to FIG. 3, it is also possible to implement the filter-driver functionality as a part of application 302, however the advantages of achieving a system-wide application-independent filtering scheme is lost. An application which would benefit from incorporating the features of the filter driver directly into the application itself is, for example, a data backup program.

FIG. 4 illustrates the tagging performed by the filter driver configured in accordance with an embodiment of the present invention. The data tagging allows the filter driver 301 to track what personality or location is to be associated with each data file. An extension is added to the file name based on the current selected personality or location. If a user is performing operations on work related files, all work files are made available, all home related documents are hidden and inaccessible from all applications. In the present example, Work personality mode will equate to “.wrk” being added to the file name. A file named Budget.xis, for example, would actually be written to the hard drive as Budget.xls.wrk. If for some reason the user needs to gain access to home related documents while at work, a quick change of the personality switch grants access to the home related documents while hiding work related documents. While this example shows two personalities/locations, Work and Personal, numerous personalities/locations are possible and desirable. Additional personalities/locations can include: Work at Home, Work While Traveling, Personal at Home, Personal at Office, Personal While on Vacation, Personal While at Recording Studio for Personal Recordings, Personal While at Recording Studio for Other's Recordings, etc. Furthermore, any of these personalities/locations can be selected/assumed by direct user input or by detection of the computer's location. In an alternative embodiment it may be desirable to require both a personality provided by a user and verifying the user selected personality by detecting an appropriate location for that personality.

FIG. 5 is a flowchart illustrating the logic of the filter driver configured in accordance with an embodiment of the present invention. In step 501, either personality input is accepted from a user or the physical location is detected by the computer system. Based on the accepted personality input provided by the user or on the physical location detected, a selected personality or location is assumed by the filter driver 301. The selected personality or location can be independent of any user login identity information. Alternatively, the selected personality or location can be tied to a user's login identity information such as a user profile (as used in the Windows® operating system) or simply a user name (as used in the Unix operating systems). Tying the selected personality to a user's login information allows different users to use the same machine while seeing different sets of files during each of their respective login sessions. When it is the location that is being determined, step 501 determines the location by assessing a system resource such as the system's network settings or the system's printer settings. Normally, a laptop personal computer is movably taken from one physical location to a different physical location and the network settings that each physical location tends to be different and unique. It is possible then, to infer based on network settings such as: IP address, RFID location tag, network gateway address, etc., the physical location of the device. Similarly, as the computer is movably taken from one physical location to a different physical location, it is usually the case that different printer settings are encountered in different physical locations. For example, at the office, a user is likely to print through a network printer, while at home, the user is likely to print through a USB or parallel port attached printer made by a different manufacturer. Either the printer's port or the printer's name or characteristics can be used to infer the physical location. A location selection is then made based on any one or more of the above made inferences.

The processes to be described relative to steps 502 and 503 occur in tandem and in response to system requests as needed. The process of step 502 occurs generally response to a write request. Similarly, the process of step 503 generally occurs in response to a read request or a directory request.

In step 502, the filter driver 301 tags the files to be stored in the disk drive or other storage device according to the selected personality or location. The tagging is done outside the purview of any application program 302. The tag is applied to the name of the file in such a way as to modify the name of the file as stored on the disk only. There area number of ways in which files can be tagged through the modification of the file's name. In general, any tagging method can be used so long as the tagging operation can be reversed/untagged in order to restore a file's name to its name existing prior to the tagging process. In the preferred embodiment, the tagging method selected is one which appends three characters to the end of the file's name as stored on the disk. If the resulting file name is too long fort he operating system in question, the filename can be reversibly compressed in length to allow the tagging to then be appended without exceeding the maximum length. Alternatively, the tagging applied to the filename can render the original filename unreadable unless viewed through the filter driver 301.

In step 503, the filter driver 301 performs filtering on files which have been saved in tagged form on the disk drive or other storage device. This step occurs in response to an application 302 attempting to read the contents of the disk drive as when attempting to obtain a listing of files stored on the disk drive. The filtering performed is as previously illustrated in FIG. 4 either with or without the encryption/decryption there illustrated. Specifically, continuing with the description of FIG. 5, filter driver 301 implements a filter which passes files which are tagged according to the selected personality or location and blocks files not tagged according to the selected personality or location. The passed files which are presented to the application programs 302 are presented with the applied tags removed such that the entire tagging process is transparent. For example, if Work is the currently-selected personality or location, a file stored on the disk as Budget.xls.wrk is presented to application program 302 as a result of the tag matching the currently-selected Work personality or location. The filtering of step 503 then removes the tagging and presents the file to the application as Budget.xls.

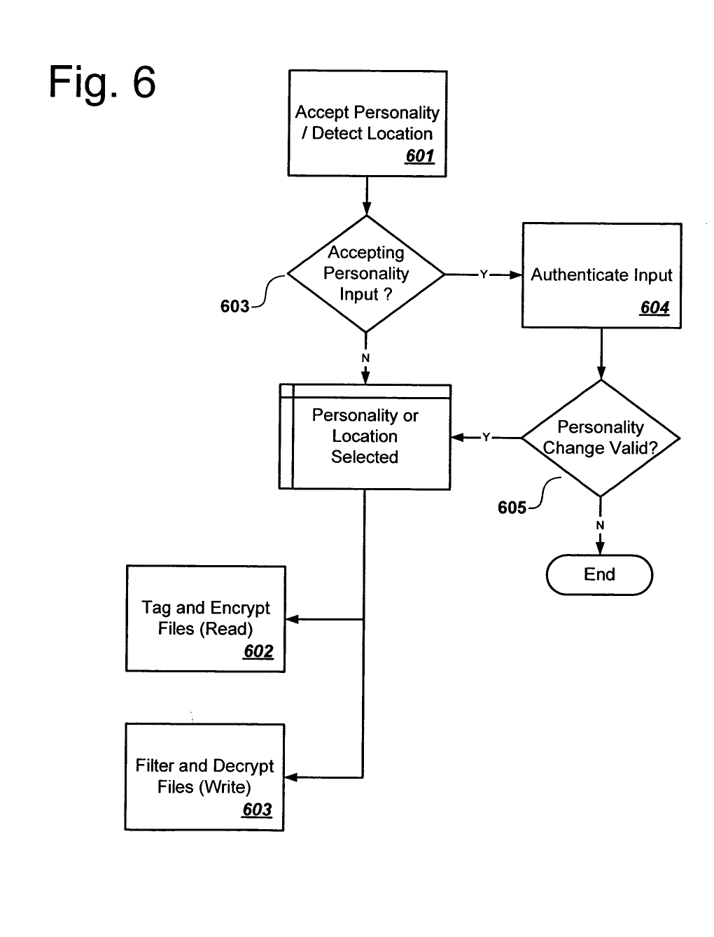

FIG. 6 is a flowchart illustrating the logic of the filter driver configured in accordance with an embodiment of the present invention. In step 601, either personality input is accepted from a user or the physical location is detected by the computer system. Based on the accepted personality input provided by the user or based on the physical location detected, a selected personality or location is assumed by the filter driver 301.

If personality data is being accepted from a user, 603, processing continues at 604; else the location is detected and thereafter processing continues at steps 602 and 603. Should processing continue at step 604, the accepted personality input data is authenticated. The authentication process can be a simple as entering a password and a strong as requiring a cryptographic coprocessor such as a Trusted Platform Module which provides hardware support for public/private key generation. At 605, if the personality change is valid, the personality is selected and processing continues at steps 602 and 603. Else the request to change personality is not executed.

The processes of steps 602 and 603 occur in tandem and in response to system requests as needed and as described relative to steps 502 and 503, i.e., generally in response to system write requests and read requests or directory read requests respectively.

The selected personality or location can be independent of any user login identity information or, as previously described in the embodiment of FIG. 5, can be tied to the user's login identity information. Regardless of whether the selected personality or location is independent of the user's login identity information, filter driver 30l is implemented such that the user need not exit an application in order to change personalities/locations. Thus, when operating in a mode where the selected personality is tied to a user's login information, the user need not log out and back in as a different user in order change personalities and/or locations. This is extremely convenient for a user who, for example, is working at home with the personality selected as Personal and wishes to quickly perform an simple office related task such as check office email, view office calendar, quickly update an office document, etc. The user need not exit existing applications. The user need only temporarily change the selected personality/location to Work and quickly perform the office related task—then simply revert the selected personality/location to Personal and continue where the user left off.

When it is the location that is being determined, step 601 determines the location by assessing a system resource such as the system's network settings or the system's printer settings as discussed relative to step 501 of FIG. 5. Summarily, location is inferred based upon one or more of: IP address, RFID location tag, network gateway address, printer name, printer type, printer port, or any other location dependent hardware parameter or registry entry.

Besides the possibility of using personality and location as has been previously mentioned, generally speaking, personality is used where convenience is desired. Location is used where security is of the utmost importance. Implementing the filter driver 301 as solely a location switch may be preferred depending on the type of application. If, for example, a laptop personal computer is intended to only be able to access work related files while at the office, filter driver 301 can be implemented as a location only switch. When the computer system detects that the location of the laptop computer has been moved off site, work related files instantly become unaccessible and invisible/undetectable. As will be described relative to process step 602, the files stored on the hard disk are stored in an encrypted form. As a result, in the event that the laptop computer is stolen, the data will be secure. Implementing the filter driver 301 with the ability to accept user initiated personality changes as verified by location presence, i.e., “personality and location” implementation, offers more flexibility than the location only implementation. For example, in the “personality and location” embodiment, it could be perfectly valid to change the personality to Personal while at the office location.

In step 602, the filter driver 301 tags the files to be stored in the disk drive or other storage device according to the selected personality or location. The tagging is done outside the purview of any application program 302. The tag is applied to the name of the file in such a way as to modify the name of the file as stored on the disk only. The tags are applied as per the description given supra relative to step 502 of FIG. 5. In addition, the files are stored on the hard disk in an encrypted format. Details concerning encryption/decryption are well known in the art and are omitted so as not to obfuscate the present disclosure in unnecessary detail. The encryption can be performed entirely within the scope of step 602, or alternatively, the code being executed in step 602 can incorporate a call to a hardware cryptographic coprocessor such as a Trusted Platform Module to assist in the encoding process. The Trusted Platform Module (TPM) can be of the type built according to the Trusted Computing Platform Alliance (TCPA) specification entitled TCPA Main Specification Version 1.1b. One example of such a TPM device is an Atmel™ part number AT97SC320.

In step 603, the filter driver 301 performs filtering on files which have been saved in tagged form on the disk drive or other storage device. This step occurs in response to an application 302 attempting to read the contents of the disk drive as when attempting to obtain a listing of files stored on the disk drive. The filtering performed is as previously illustrated in FIG. 4 and as previously described in FIG. 5 with reference to process step 503. In addition, the files are retrieved from the hard disk and if the file had been encrypted it is then decrypted in this step. The decryption can be performed entirely within the scope of step 603, or alternatively, the code being executed in step 603 can incorporate a call to a hardware cryptographic coprocessor such as a TPM to assist in the decoding process. The filtering process of step 603 can have a built-in override for files tagged as universal. One such universal tag “.uni” is shown in FIG. 4 fort he file saved on the hard disk as “Stocks.htm.uni.” When implementing this override, files tagged as universal are passed regardless of the currently selected personality or location. Thus, in the case of the file “Stocks.htm.uni,” without regard to the currently selected personality or location this file is passed to application 302 as “Stocks.htm.” Tagging files as universal is accomplished by switching to a universal personality prior to saving the files in step 602. In addition, filter driver 301 can be implemented such that when the universal personality is selected, all files on the hard disk are passed/decrypted regardless of any tagging that exists on-disk.

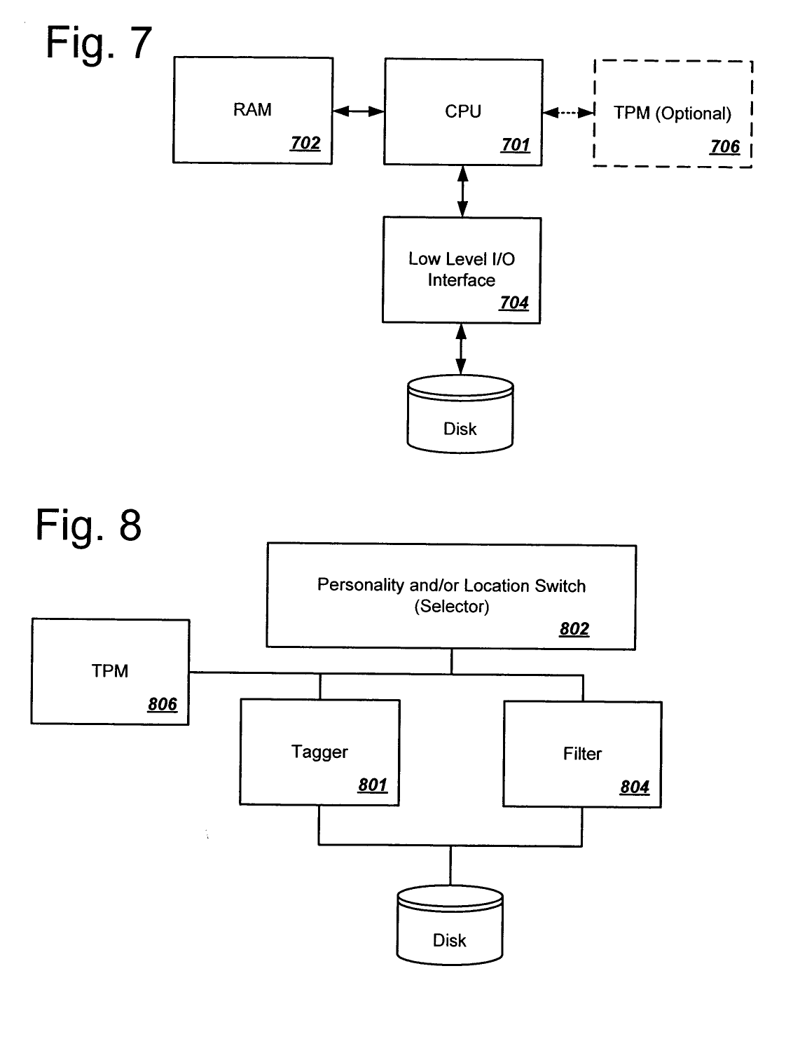

FIG. 7 is a block diagram of an apparatus configured in accordance with an embodiment of the present invention. The apparatus includes CPU 701 which executes code stored in RAM 702. CPU 701 interfaces to a disk drive or other storage device through low level I/O interface 704. This embodiment would be considered a firmware/hardware embodiment of the present invention in that the code as previously described in the present disclosure in relation to any of the previous embodiments is loaded into RAM 702 and executed by the CPU 701. In this embodiment, CPU 701 can execute any of the authentication, encryption, and decryption functions heretofore described. Optionally, the CPU can make a call to a TPM 706 for any one or all of these cryptographic functions. A display (not shown) can be used to solicit input from a user in instances where personality selection input is desired.

FIG. 8 is a block diagram of an apparatus configured in accordance with an embodiment of the present invention. This embodiment is implemented largely in hardware. Personality and/or location switch 802 is functionally coupled to Tagger 801, filter 804, and TPM 806 through a bus or a series of buses configured either serially for hierarchically. One or all of these components 802 801, 804, and 806 can be implemented entirely in hardware, or can be implemented with an internal microprocessor running internally stored microcode. TPM 806 is preferably a cryptographic processor as previously described herein. Personality and/or location switch 802 contains logic which performs the functions of any of the embodiments described, supra, in relation to step 501 of FIG. 5 and steps 601, 603, 604, 605 of FIG. 6. Likewise, Tagger 801 contains logic which performs the functions of any of the embodiments described, supra, in relation to step 502 of FIG. 5 and step 602 of FIG. 6. Similarly, filter 804 contains logic which performs the functions of any of the embodiments described, supra, in relation to step 503 of FIG. 5 and step 603 of FIG. 6. Personality and/or location switch 802, Tagger 801, and filter 804 each independently make calls to TPM 806 for cryptographic processor support. Tagger 801 and filter 804 can be situated to access the disk directly or to use a low level I/O interface has shown in FIG. 7 as item 704.

In the drawings and specifications there has been set forth a preferred embodiment of the invention and, although specific terms are used, the description thus given uses terminology in a generic and descriptive sense only and not for purposes of limitation.

1. A program product comprising:
a computer useable medium having computer readable program code stored therein, the computer readable program code in said program product being effective when executing to:
determine the location of a computer which has a storage device adapted to store various data files and assume a selected location in the computer based on the determined location;
tag files to be stored in the storage device according to the selected location; and
implement a filter which (a) passes files tagged according to the selected location and removes the tags applied by the code which is effective to tag and which (b) blocks files not tagged according to the selected location.

2. The product of claim 1 wherein the code which is effective to tag files is code which appends characters to the data file name.

3. The product of claim 1 wherein the location is determined by assessing a system resource.

4. The product of claim 3 wherein the system resource is selected from the group consisting of network settings and printer settings.

5. A program product comprising:
a computer useable medium having computer readable program code stored therein, the computer readable program code in said program product being effective when executing to:
determine the location of a computer which has a storage device adapted to store various data files and assume a selected location in the computer based on the determined location;
tag files to be stored in the storage device according to the selected location wherein the contents of the tagged files are stored in an encrypted format on the storage device; and
implement a filter which (a) passes files tagged according to the selected location and removes the tags applied by the code which is effective to tag files and decrypts the contents of tagged files which have been stored in an encrypted format on the storage device and which (b) blocks files not tagged according to the selected location;
wherein, when at least one application is executed in the computer, a change in the selected location based on a newly determined location does not require termination of the at least one application.

6. The product of claim 5 wherein the code which implements the filter further passes files tagged as universal irrespective of the selected location and thereby overrides the filter action (b) which otherwise blocks files not tagged according to the selected location.

7. The product of claim 5 wherein a call to a cryptographic processor is made in a selected one of the location determination performed by the code which determines, the encryption performed by the code which implements the filter, and the decryption performed the code which implements the filter.

8. The product of claim 7 wherein the cryptographic processor called is a trusted platform module.

9. The product of claim 5 wherein the code which is effective to tag files is code which appends characters to the data file name.

10. The product of claim 5 wherein the location is determined by assessing a system resource.

11. The product of claim 10 wherein the system resource is selected from the group consisting of network settings and printer settings.

12. A method comprising the steps of:
determining the location of a computer which has a storage device adapted to store various data files and assuming a selected location in the computer based on the determined location;
tagging files to be stored in the storage device according to the selected location; and
implementing a filter which (a) passes files tagged according to the selected location and removes the tagging applied in said tagging step and which (b) blocks files not tagged according to the selected location.

13. The method of claim 12 wherein said tagging is one which appends characters to the data file name.

14. The method of claim 12 wherein the location of said determining step is determined by assessing a system resource.

15. The method of claim 14 wherein the system resource is selected from the group consisting of network settings and printer settings.

16. A method comprising the steps of:
determining the physical location of a computer which has a storage device adapted to store various data files and assuming a selected location in the computer based on said determination;
tagging files to be stored in the storage device according to the selected location wherein the contents of the tagged files are stored in an encrypted format on the storage device; and
implementing a filter which (a) passes files tagged according to the selected location and removes the tagging applied in said tagging step and decrypts the contents of tagged files which have been stored in an encrypted format on the storage device and which (b) blocks files not tagged according to the selected location;
wherein, when at least one application is running in the computer, a change in the selected location based on newly determined location does not require termination of the at least one application.

17. The method of claim 16 wherein the filter implemented in said implementing step further passes files tagged as universal irrespective of the selected location and thereby overrides the filter action (b) which otherwise blocks files not tagged according to the selected location.

18. The method of claim 16 wherein a cryptographic processor is utilized in a selected one of the location determination in said determining step, the encryption performed in said filter implementing step, and the decryption performed in said filter implementing step.

19. The method of claim 18 wherein the cryptographic processor is a trusted platform module.

20. The method of claim 16 wherein the tagging in said tagging step is one which appends characters to the data file name.

21. The method of claim 16 wherein the location of said determining step is determined by assessing a system resource.

22. The method of claim 21 wherein the system resource is selected from the group consisting of network settings and printer settings.

23. Apparatus comprising:
a location switch which determines the physical location of a computer having a storage device capable of storing various data files, the location switch indicating a selected location based on the determined location;
a tagger which is coupled to said location switch and which tags files to be stored in the storage device by modifying the names of the files according to the selected location as indicated by said location switch; and
a filter which is coupled to said location switch and which (a) passes files tagged according to the selected location by restoring each file name to the name existing prior to the modification performed by said tagger and which (b) blocks files not tagged according to the selected location.

24. Apparatus of claim 23 wherein the data file name modification is one which appends characters to the data file name.

25. Apparatus of claim 23 wherein the location is determined by assessing a system resource.

26. Apparatus of claim 25 wherein the system resource is selected from the group consisting of network settings and printer settings.

27. Apparatus comprising:
a location selector which determines the location of a computer and which indicates a selected location based on the determined location, wherein a storage device included in the computer is capable of storing various data files;
a tagger which is coupled to said location selector and which tags files to be stored in the storage device by modifying the names of the files according to the selected location as indicated by said location selector and which stores the contents of the tagged files in an encrypted format on the storage device; and
a filter which is coupled to said location selector and which (a) passes files tagged according to the selected location by restoring each file name to the name existing prior to the modification performed by said tagger and by decrypting the contents of tagged files which have been stored in an encrypted format on the storage device and which (b) blocks files not tagged according to the selected location;
wherein, when at least one application is running in the computer, a change in the selected location based on a newly determined location does not require termination of the at least one application.

28. Apparatus of claim 27 wherein said filter further passes files tagged as universal irrespective of the selected location, thereby overriding the blocking (b) of files not tagged according to the selected location.

29. Apparatus of claim 27 wherein a cryptographic processor is utilized in a selected one of the location determination performed by said location selector, the encryption performed by said filter, and the decryption performed by said filter.

30. Apparatus of claim 29 wherein the cryptographic processor is a trusted platform module.

31. Apparatus of claim 27 wherein the location is determined by assessing a system resource.

32. Apparatus of claim 31 wherein the system resource is selected from the group consisting of network settings and printer settings.
